(19) United States
(12) Patent Application Publication
(10) Pub. No.: US 2008/0156299 A1
(43) Pub. Date: Jul. 3, 2008

(54) FUEL DISTRIBUTOR

(76) Inventors: Thomas SEBASTIAN, Erdmannhausen (DE); Bill Warner, Summerville, SC (US)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/950,688

(22) Filed: Dec. 5, 2007

(30) Foreign Application Priority Data
Dec. 27, 2006 (DE) 10 2006 061 563.8

(51) Int. Cl. F02M 55/02; F02M 61/14

(52) U.S. Cl. 123/470; 123/469

(57) ABSTRACT

A fuel distributor for a fuel injection system for internal combustion engines which has a two-shell housing with receptacles for mounting injection devices, which housing is put together from a rigid first housing shell and an elastic second housing shell covering the first. To reduce production costs and shorten the assembly time, the two housing shells are deep-drawn from a preferably stainless metal sheet, and the receptacles are formed integrally in one piece with the first housing shell, and a connection stub for a fuel line is formed integrally in one piece with the second housing shell.

### REFERENCE TO FOREIGN PATENT APPLICATION

This application is based on German Patent Application No. 10 2006 061 563.8 filed 27 Dec. 2006, upon which priority is claimed.

### BACKGROUND OF THE INVENTION

1. Field of the Invention

The invention is based directed to an improved fuel distributor, in particular for a fuel injection system for internal combustion engines.

2. Description of the Prior Art

In a known fuel distributor of the type with which this invention is concerned, disclosed in German Patent Disclosure DE 34 32 727 A1, the two-shell housing is put together from a rigid lower shell of U-shaped cross section and a thin-walled, elastic upper shell of triangular cross section that covers the lower shell. The elastic upper shell has fastening side walls, which protrude into the rigid lower shell and are soldered or welded to it. While the rigid lower shell assures the strength of the fuel distributor, the elastic, thin upper shell, because of the elastic deformability resulting from its thin-walled nature, damps pressure pulsations in the fuel line and reduces the noise they create. In addition, receptacles for inserting fuel injection valves are reserved in the rigid lower shell. The receptacles are inserted in the form of separate bushes into holes that are present in the bottom of the lower shell and are secured in the holes, for instance by soldering. The fuel injection valves are inserted into the bushes and fastened with clamps.

A known high-pressure fuel reservoir, supplied with fuel by a high-pressure fuel pump, for a fuel injection system for internal combustion engines (German Utility Model DE 25 21 402 U1) has an elongated forged tubular body, on the jacket face of which connection stubs for delivering and removing fuel are integrally formed. The connection stubs serve as connections to electrically controlled fuel injection valves, and one connection stub serves to connect the high-pressure fuel pump. On the side of the tubular body facing away from the connection stubs, fastening eyelets for fastening the fuel reservoir in the motor vehicle are formed on in the form of eyelets.

### OBJECT AND SUMMARY OF THE INVENTION

The fuel distributor of the invention has the advantage that the complete fuel distributor now comprises only two, preferably deep-drawn metal sheets, which merely have to be joined together. No further components have to be produced and/or assembled, so that both production and assembly are simplified substantially, and the assembly time is shortened markedly. The tightness of the fuel distributor is produced solely by the connection between the two housing shells. There are no other points that have to be sealed. As in the prior art, the thin-walled, elastic second housing shell, preferably embodied as a flat lid, still assures adequate damping of the pressure pulsations in the fuel line. The two-shelled nature offers a high degree of freedom for utilizing the installation space available in the motor vehicle. Because all the receptacles are disposed in the first housing shell, all the geometries required for orienting injection valves with the cylinder head are combined in one component. This reduces the chain of tolerances considerably and leads to more-precise positioning of the injection stream and thus to lower emissions, especially HC emissions.

In one advantageous embodiment of the invention, there are fastening eyelets on the housing, which in the form of fastening straps and fastening eyes are integrally formed onto the housing shells in one piece with them. The fastening straps on the two housing shells are placed in such a way that when the housing shells have been put together to make the housing, the fastening staps rest on one another. Because of this embodiment of the fastening straps, a greater wall thickness for the fastening eyelets and thus greater strength are attained, while the integral forming of the fastening straps onto the housing shells is still simple.

### BRIEF DESCRIPTION OF THE DRAWINGS

The invention will be better understood and further objects and advantages thereof will become more apparent from the ensuing detailed description of a preferred embodiment, taken in conjunction with the drawings, in which:

FIG. 1 shows a perspective view of a fuel distributor according to the invention, with a fuel injection valve inserted as an example;

FIG. 2 is a side view of the fuel distributor in the direction of arrow II in FIG. 1;

FIG. 3 is a top view of the fuel distributor in the direction of arrow III in FIG. 2;

FIG. 4 is a section taken along the line injection valve-IV in FIG. 3; and

FIG. 5 is a longitudinal section through the enlarged detail V in FIG. 2.

### DESCRIPTION OF THE PREFERRED EMBODIMENT

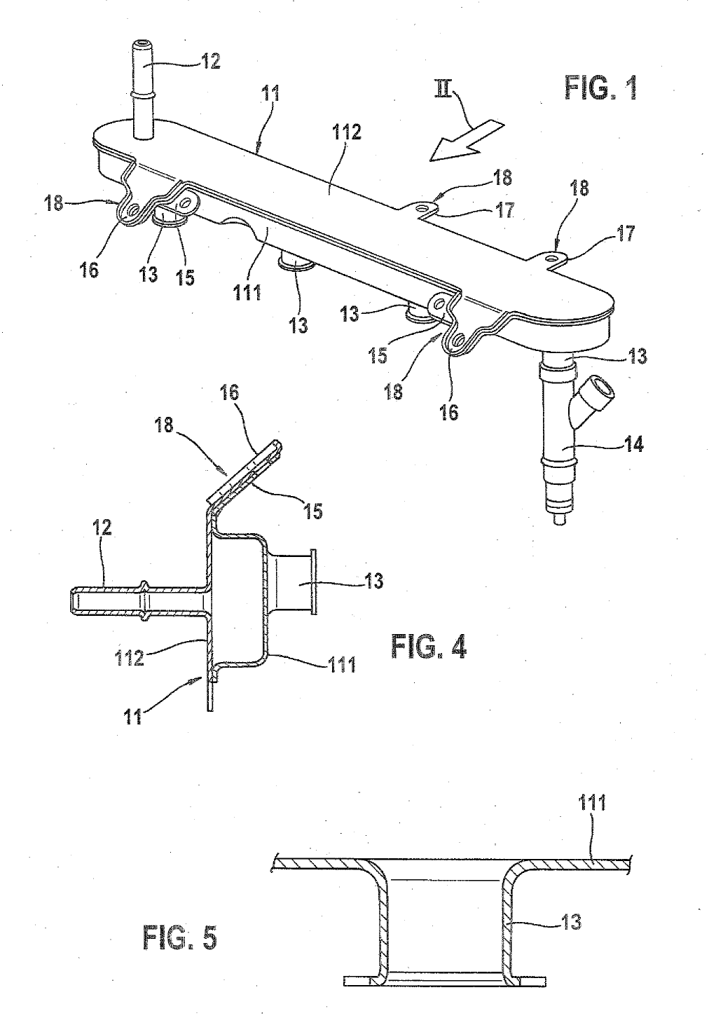

The fuel distributor show in perspective in FIG. 1, for instance for a fuel injection system for internal combustion engines, has an elongated housing 11, on which a connection stub 12 for a fuel line, not shown, and a plurality of receptacles 13. In the exemplary embodiment of FIG. 1, four receptacles 13 each for one injection valve 14, are disposed. In FIG. 1, one injection valve 14 is shown as an example; it is inserted into the receptacle 13 located farthest away from the connection stub 12 and is secured therein.

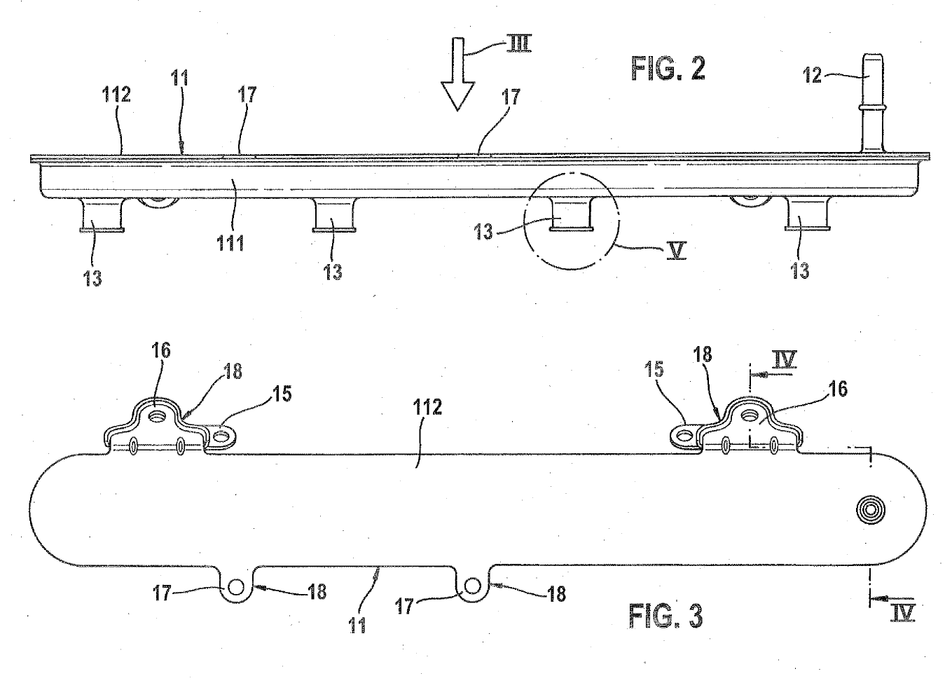

The housing 11 shown in perspective in FIG. 1, in a side view in FIG. 2, in a top view in FIG. 3, and in section in FIG. 4, is in two-shell form and is put together from one first, rigid, housing shell 111 and one second, thin-walled and elastic, housing shell 112. The first housing shell 111 is embodied as a tub and the second housing shell 112 is embodied as a flat lid; the flat second housing shell 112 rests on the rim of the tub of the first housing shell 111. Along the rim of the tub, the two housing shells 111 and 112 are joined together in fluid-tight fashion, for instance by soldering or welding. The receptacles 13, disposed on the bottom of the tub of the first housing shell 111, for the injection valves 14 are integrally formed, in the form of cups, onto the first housing shell 111 in one piece with it (FIG. 5). The connection stub 12 is likewise formed integrally onto the second housing shell 112 in one piece with it (FIG. 4). For fastening the fuel distributor in the motor vehicle, fastening eyelets 18, in the form of fastening straps 15, 16 and fastening eyes 17, are provided on the housing 11. Two fastening straps 15 on the first housing shell 111 and two fastening straps 16 as well as two fastening eyes 17, disposed on the side of the second housing shell 112 diametrically opposite the fastening straps 16, on the second housing shell 112 are each formed integrally onto the respective housing shell 111 and 112 and in one piece with them. The disposition of the fastening straps 15 on the first housing shell 111 and of the fastening straps 16 on the second housing shell 112 is done in such a way that when the housing shells 111, 112 rest on one another, one fastening strap 15 and one fastening strap 16 each rest on one another, thus creating one fastening eyelet 18, with a thickness corresponding to the total wall thicknesses of the fastening straps 15, 16 together. One such fastening eyelet 18 is shown in section in FIG. 4, while in FIGS. 1 and 3 all the fastening eyelets 18 can be seen in a top view. The two housing shells 111 and 112 with the cuplike receptacles 13, connection stub 12, fastening straps 15, 16 and fastening eyes 17, formed integrally in one piece, are deep-drawn from stainless sheet steel.

The foregoing relates to a preferred exemplary embodiment of the invention, it being understood that other variants and embodiments thereof are possible within the spirit and scope of the invention, the latter being defined by the appended claims.

We claim:

1. A fuel distributor for a fuel injection system for internal combustion engines, the distributor comprising a two-shell housing that is put together from a rigid first housing shell, and an elastic second housing shell covering and forming a fluid-tight connection with the first, a plurality of receptacles for mounting injection devices embodied in one piece with the first housing shell, and a connection stub for a fuel line embodied in one piece with one of the two housing shells each of the two housing shells being shaped, preferably deep-drawn, from a metal sheet.

2. The fuel distributor as defined by claim 1, wherein the connection stub is formed integrally onto the second housing shell in one piece with it.

3. The fuel distributor as defined by claim 1, further comprising fastening eyelets on the housing for installing the fuel distributor.

4. The fuel distributor as defined by claim 2, further comprising fastening eyelets on the housing for installing the fuel distributor.

5. The fuel distributor as defined by claim 3, comprising at least one group of the fastening eyelets formed of two fastening straps each resting on one another, of which one fastening strap is integrally formed onto the first housing shell in one piece with it and the fastening strap is integrally formed onto the second housing shell in one piece with it.

6. The fuel distributor as defined by claim 4, comprising at least one group of the fastening eyelets formed of two fastening straps each resting on one another, of which one fastening strap is integrally formed onto the first housing shell in one piece with it and the fastening strap is integrally formed onto the second housing shell in one piece with it.

7. The fuel distributor as defined by claim 3, comprising a further group of fastening straps embodied as fastening eyes or fastening eyelets formed integrally in one piece onto the second housing shell.

8. The fuel distributor as defined by claim 4, comprising a further group of fastening straps embodied as fastening eyes or fastening eyelets formed integrally in one piece onto the second housing shell.

9. The fuel distributor as defined by claim 5, comprising a further group of fastening straps embodied as fastening eyes or fastening eyelets formed integrally in one piece onto the second housing shell.

10. The fuel distributor as defined by claim 6, comprising a further group of fastening straps embodied as fastening eyes or fastening eyelets formed integrally in one piece onto the second housing shell.

11. The fuel distributor as defined by claim 1, wherein the first housing shell is embodied as a tub having a peripheral rim and the second housing shell is embodied as a flat lid, and the second housing shell rests on the rim of the tub of the first housing shell; and wherein the two housing shells are joined to one another in fluid-tight fashion along the rim of the tub.

12. The fuel distributor as defined by claim 2, wherein the first housing shell is embodied as a tub having a peripheral rim and the second housing shell is embodied as a flat lid, and the second housing shell rests on the rim of the tub of the first housing shell; and wherein the two housing shells are joined to one another in fluid-tight fashion along the rim of the tub.

13. The fuel distributor as defined by claim 3, wherein the first housing shell is embodied as a tub having a peripheral rim and the second housing shell is embodied as a flat lid, and the second housing shell rests on the rim of the tub of the first housing shell; and wherein the two housing shells are joined to one another in fluid-tight fashion along the rim of the tub.

14. The fuel distributor as defined by claim 5, wherein the first housing shell is embodied as a tub having a peripheral rim and the second housing shell is embodied as a flat lid, and the second housing shell rests on the rim of the tub of the first housing shell; and wherein the two housing shells are joined to one another in fluid-tight fashion along the rim of the tub.

15. The fuel distributor as defined by claim 6, wherein the first housing shell is embodied as a tub having a peripheral rim and the second housing shell is embodied as a flat lid, and the second housing shell rests on the rim of the tub of the first housing shell; and wherein the two housing shells are joined to one another in fluid-tight fashion along the rim of the tub.

16. The fuel distributor as defined by claim 7, wherein the first housing shell is embodied as a tub having a peripheral rim and the second housing shell is embodied as a flat lid, and the second housing shell rests on the rim of the tub of the first housing shell; and wherein the two housing shells are joined to one another in fluid-tight fashion along the rim of the tub.

17. The fuel distributor as defined by claim 9, wherein the first housing shell is embodied as a tub having a peripheral rim and the second housing shell is embodied as a flat lid, and the second housing shell rests on the rim of the tub of the first housing shell; and wherein the two housing shells are joined to one another in fluid-tight fashion along the rim of the tub.

18. The fuel distributor as defined by claim 11, wherein the fluid-tight connection between the two housing shells is produced by soldering or welding.

19. The fuel distributor as defined by claim 7, wherein the fluid-tight connection between the two housing shells is produced by soldering or welding.

20. The fuel distributor as defined by claim 1, wherein the metal sheets are stainless steel sheets.
